(19) United States
(12) Patent Application Publication
(10) Pub. No.: US 2011/0239572 A1
(43) Pub. Date: Oct. 6, 2011

(54) Thin-Tile Laminated Mosaic Sheet

(75) Inventor: Omer Calapkulu, Kennesaw, GA (US)

(73) Assignee: STONEXPRESS, INC., Kennesaw, GA (US)

(21) Appl. No.: 13/078,302

(22) Filed: Apr. 1, 2011

Related U.S. Application Data
(60) Provisional application No. 61/320,651, filed on Apr. 2, 2010.

(51) Int. Cl. E04F 13/09; B32B 37/22; E04G 21/14; E04F 13/21

(52) U.S. Cl. 52/390; 156/182; 52/742.16

(57) ABSTRACT

A laminated tile mosaic sheet having a laminated sheet made of a mesh grid and a plurality of tiles each with an ornamental surface and attached in spaced apart relation to have gaps between the tiles, and a backer sheet having a first adhesive surface and an opposing second adhesive surface and a second mesh grid, the laminated sheet attached to the first adhesive surface, and a cover sheet detachably attached to the second adhesive surface, whereby the tile mosaic sheet attaches to a surface upon removal of the cover sheet. A method of installing a thin-tile mosaic sheet to a surface is disclosed.

The present application claims the benefit of U.S. Provisional Patent Application Ser. No. 61/320,651, filed Apr. 2, 2010, which specification and drawings are incorporated herein in their entireties by reference.

### TECHNICAL FIELD

The present invention relates to tiles for covering wall and floor surfaces to provide an ornamental treatment. More particularly, the present invention relates to thin-tile laminated mosaic sheets for wall and floor surface treatment.

### BACKGROUND OF THE INVENTION

Walls of buildings are typically finished with a variety of treatments that provide a finished ornamental appearance. These treatments include painting, wall paper, tiles, and other finishing treatments. Tiles come in a range of materials and sizes. The tiles may be made of ceramic, porcelain, stone, composites, or other suitable tile-forming materials. While these various treatments provide ornamental effects, installation and mounting of these treatments varies. For example, painting involves applying an overcoat of a flowable material to a substrate such as dry wall.

Applying tiles to surfaces such as walls, however, is more involved, and includes other materials and techniques. After the wall supporting structure is constructed, for example, a plurality of wall studs mounted to a header and a footer, the support structure is typically closed by attaching one or more sheets of a wall board to the studs. This defines a planar surface of the wall. The wall surface receives a layer of thin-set mortar. Tiles are placed in spaced-relation into the mortar. Spacer devices insert between adjacent tiles to maintain a predetermined spacing or gap between adjacent tiles. Upon the curing of thin-set mortar, the tiles are rigidly adhered to the wall surface. The spacers are removed and the gaps between the adjacent tiles are filled with grout.

Installation of such tile surfaces on walls is time consuming and expensive because of the labor in applying the thin-set mortar and in measuring, cutting, and positioning the tiles in spaced relation in the thin-set mortar. Tile surfaces are not readily changed. In the event that a wall is removed (for example, to replace dry wall damaged from flooding), the tile surface must be removed. Also, if a change in ornamental appearance is desired, the tile surface and the existing mortar must be removed prior to applying a new layer of thin-set mortar for receiving the new tile surfaces.

Accordingly, there is a need in the art for a tile device and method for installing tiles on a wall surface. It is to such that the present invention is directed.

### BRIEF SUMMARY OF THE INVENTION

The present invention meets the need in the art by providing a laminated tile mosaic sheet, comprising a laminated sheet comprising a mesh grid with a plurality of tiles attached in spaced apart relation to the mesh grid, and the adjacent tiles defining gaps therebetween and each tile having an ornamental surface. A backer sheet has a first adhesive surface and an opposing second adhesive surface. The backer sheet includes a second mesh grid. The laminated sheet attaches to the first adhesive surface. A detachable cover sheet overlies the second adhesive surface. The tile mosaic sheet attaches to a surface upon removal of the detachable cover sheet.

In another aspect, the present invention provides a method of making a laminated tile mosaic sheet, comprising the steps of:

(a) providing a laminated sheet having a plurality of spaced-apart tiles attached to a first mesh grid, the tiles are thin-cut natural stone having a thickness of about 4 mm;

(b) providing a second mesh grid to a backer sheet having a first adhesive surface and an opposing second adhesive surface;

(c) attaching the laminated sheet to the first adhesive surface of the backing sheet; and

(d) detachably attaching a cover sheet to the second adhesive surface,

whereby the laminated tile mosaic sheet attaches to a surface upon detaching the cover sheet.

In another aspect, the present invention provides a method of installing a thin-tile mosaic sheet for ornamental treatment of a wall surface, comprising the steps of:

(a) providing a plurality of laminated tile mosaic sheets, each laminated tile mosaic sheet comprising:
a laminated sheet comprising:
   a mesh grid; and
   a plurality of tiles attached in spaced apart relation to the mesh grid, adjacent tiles defining gaps therebetween and each tile having an ornamental surface;
a backer sheet having a first adhesive surface and an opposing second adhesive surface, the first laminated sheet attached to the first adhesive sheet;
the backer sheet including a second mesh grid; and
a cover sheet detachably attached to the second adhesive surface;

(b) removing the detachable cover sheet of one of the laminated tile mosaic sheets;

(c) attaching the laminated tile mosaic sheet in overlying relation to a predetermined portion of a wall surface without previously removing an existing ornamental treatment on the wall surface;

(d) repeating steps (b) and (c) until a desired portion of the wall surface is covered with the attached laminated tile mosaic sheets;

(e) applying a grout material to fill at least partially the gaps between adjacent tiles; and

(f) wiping grout material from the ornamental surface of the tiles.

Objects, advantages, and features of the present invention will become readily apparent upon reading the following detailed description in conjunction with the drawings and the appended claims.

### BRIEF DESCRIPTION OF THE DRAWINGS

FIG. 1 illustrates in perspective cut-away view a mosaic sheet of a plurality of thin-cut tiles for attaching to a wall surface.

FIG. 2 illustrates in detailed view a cross-section of the mosaic sheet illustrated in FIG. 1.

FIG. 3 illustrates an apparatus for assembly of the thin-tile mosaic sheet illustrated in FIG. 1.

FIG. 4 illustrates in perspective view a wall having an existing surface treatment being covered with a plurality of thin-tile mosaic sheets illustrated in FIG. 1, to provide a second surface treatment for the wall.

### DETAILED DESCRIPTION

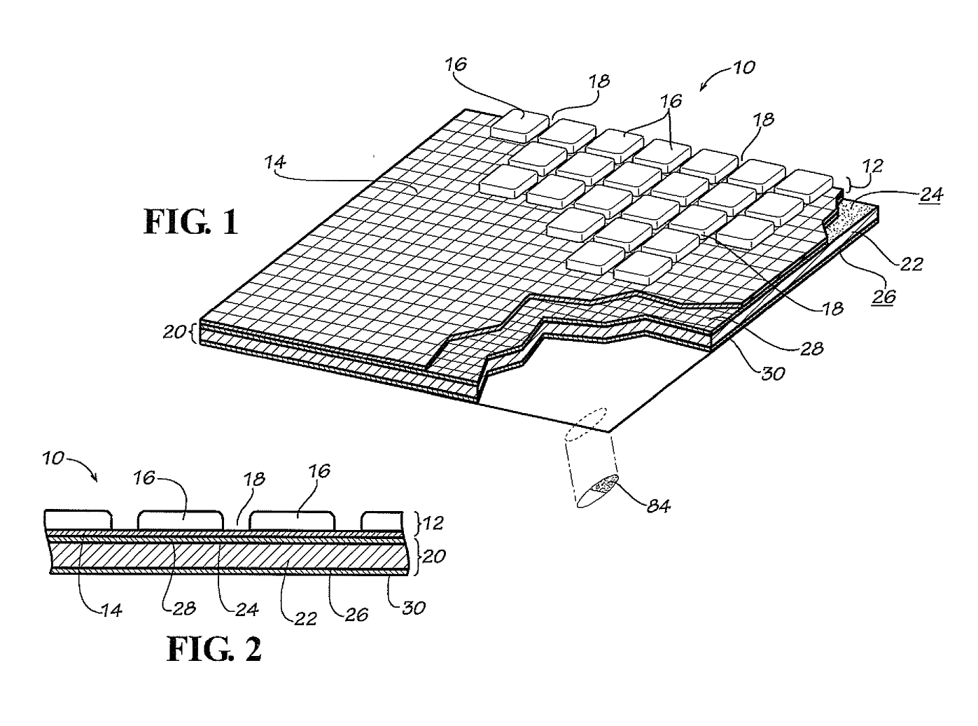

With reference to the drawings in which like parts have like referenced numerals, FIG. 1 illustrates in cut-away perspective view a mosaic sheet 10 having a laminated sheet generally 12 of a mesh grid 14 to which a plurality of thin-cut tiles 16 attach in spaced-apart relation. The spacing of the tiles 16 thereby defines gaps 18 between adjacent tiles. The laminated sheet 12 attaches to a substrate or backer sheet generally 20 for attaching to a wall surface. The backer sheet 20 includes a resilient sheet 22 with a first adhesive surface 24 and an opposing second adhesive surface 26. The backer sheet 20 further includes a second mesh grid 28. In the illustrated embodiment, the second mesh grid 28 attaches to the first adhesive surface 24. The laminated sheet 12 attaches in overlying relation to the first adhesive surface with the mesh grid 14 in contacting relation with the second mesh grid 28. In an alternate embodiment (not illustrated), the second mesh grid 28 is sandwiched within the resilient sheet 22. A cover sheet 30 detachably attaches to the second adhesive surface 26. As discussed below, the cover sheet 30 detaches for exposing the second adhesive surface 26 by which the laminated mosaic sheet 10 attaches to the wall surface.

FIG. 2 illustrates in detail view a cross-section of the mosaic sheet 10 illustrated in FIG. 1, with exaggerated thickness for purposes of illustration. The laminated sheet 12 is an assembly that includes the mesh grid 14 with the plurality of spaced-apart tiles 16 attached, for example, with adhesive. This assembly attaches to the backer sheet 20 in overlying relation to the second mesh grid 28 and the first adhesive surface 24. The cover sheet 30 overlies the second adhesive surface and is removed during installation of the mosaic sheet 10 to a wall surface as discussed below. An adhesive tab facilitates removal of the cover sheet.

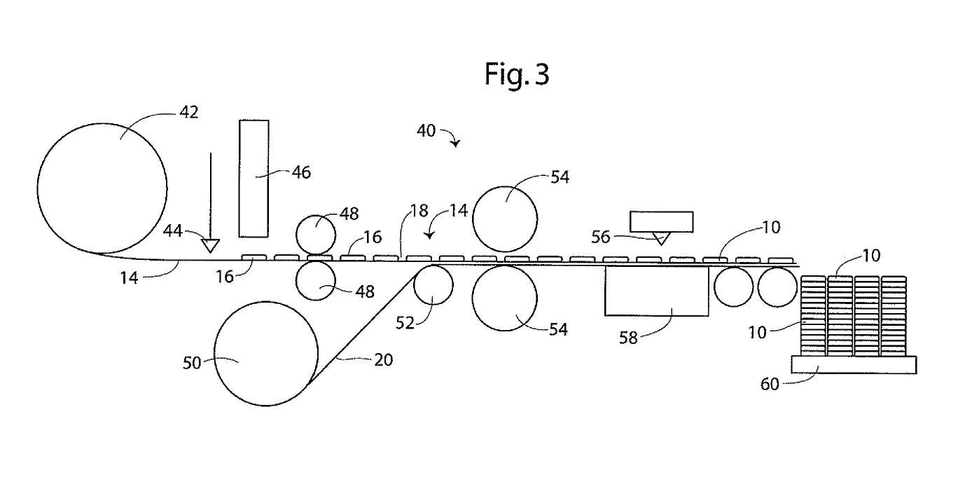

FIG. 3 illustrates in schematic view an apparatus 40 for assembly of the thin-tile mosaic sheet 10 illustrated in FIG. 1. The apparatus 40 includes a supply 42 of the mesh grid 14, such as from a roll supply. An adhesive nozzle 44 communicates with a supply of adhesive. The nozzle 44 applies an adhesive coating to the mesh grid 14. A deposit station 46 places a row of the tiles 16 in spaced-part relation onto the adhesive coating on the mesh grid 14. A pair of opposing rollers 48 press the tiles 16 into firm engagement with the adhesive on the mesh grid 14 to form an assembled laminated sheet 14. The laminated sheet 14 attaches in overlying relation to an adhesive surface of the backer sheet 20. Particularly, the apparatus 40 includes a supply 50 of backer sheet 20. A guide roller 52 directs the backer sheet 20 into relation with the laminated sheet 14. The mesh grid 14 of the laminated sheet overlies the mesh grid 28 attached to the resilient sheet 22 and engages the first adhesive surface 24. Opposing rollers 54 firmly push the laminate sheet 14 and the backer sheet 20 together to form the laminated thin-tile mosaic sheet 10. A knife 56 periodically operates to cut separated ones of the laminated mosaic sheets 10. The knife 56 bears against an anvil 58. A stacker generally 60 receives the separated laminated mosaic sheets 10.

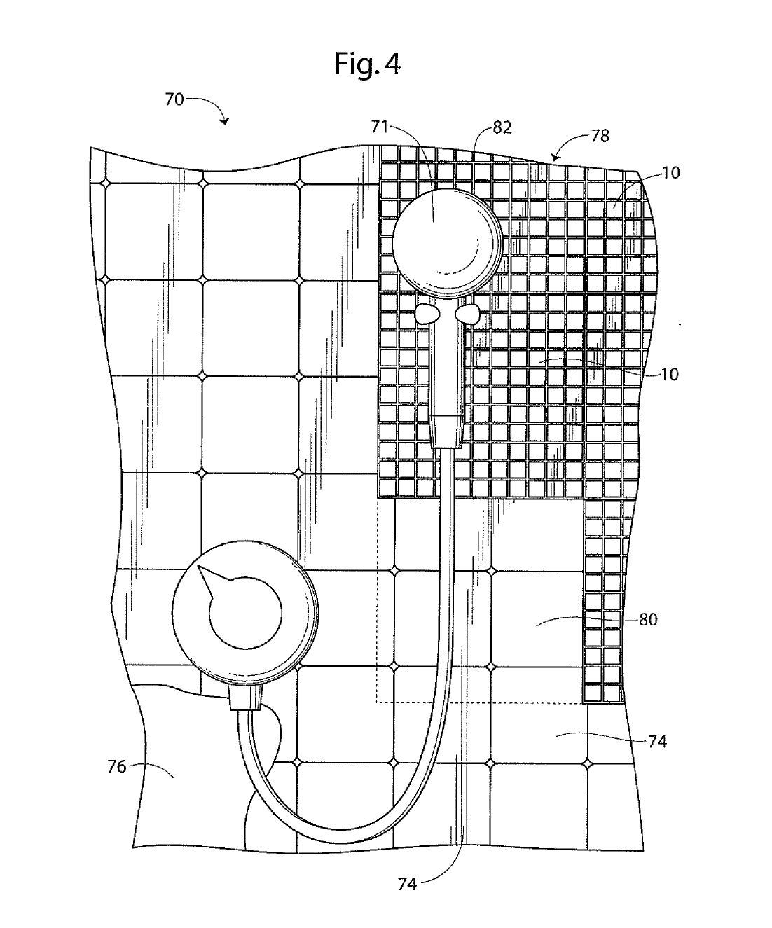

FIG. 4 illustrates in perspective view a wall 70 of a shower having a wall fixture showerhead 71 (as an illustrative embodiment and not of limitation) having an existing wall treatment generally 72 of tiles 74 attached to a shower wall board 76. A plurality of the laminated mosaic sheets 10 attach to and cover a portion generally 78 of the wall to provide a new surface treatment. During installation, a portion 80 (shown for illustrative purposes in dashed lines) is selected, and one of the mosaic sheets 10 is adhesively attached in overlying relation.

The backer sheet 20 replaces mortar, thin set mortar or mastic for setting of tiles. Various sizes of tiles and types of tiles can be gainfully used with the laminated mosaic sheets 10 of the present invention. Sizes range for example from 1 inch by 1 inch up to about 6 inch by 6 inch tiles. Tile materials useful with this invention include ceramic, porcelain, and natural stone. A particularly preferred tile however is a thin-cut natural stone 1 inch by 1 inch tile having a thickness of about 4 mm, for example, GIALLO travertine tumbled mosaic tiles available from Ege Jeoteknik, of Izmir, Turkey. Thin-cut natural stone tiles are lighter weight than conventional cut stone or other material tiles. It is to be appreciated that the mosaic sheet device of the present invention is gainfully used on surfaces other than shower walls.

With reference to FIGS. 1, 2, and 4, a plurality of the laminated thin-tile mosaic sheets 10 install onto a wall surface for creating an ornamental treatment. This is accomplished by removing the detachable cover sheet 30 of one of the laminated tile mosaic sheets 10. An adhesive tab 84 (depicted for convenience in FIG. 1) can be used to attach to the cover sheet 30 and then gripped to peel the cover sheet from the backer sheet 22. This uncovers the second adhesive surface 26. The uncovered mosaic sheet 10 then attaches to a preselected portion of the wall surface. The mosaic sheet 10 can attach directly to a wall board or in overlying relation to an existing wall treatment such as the tiles 74. The second adhesive surface 26 engages and bonds to the wall surface. A roller or foam-covered plate can be used to push against the mosaic sheet 10 to firmly adhere the mosaic sheet 10 to the wall surface. Additional portions 80 are selected, and the installation process is repeated, until the wall surface is covered. Conventional tile spacers (not illustrated) can be used to maintain spacing between adjacent sheets 10. Upon completion, the installer then applies a conventional grout material 82 over the tiles 16 and fills the gaps 18. The grout material is wiped with a conventional wiper or sponge. Upon curing of the grout material, the wall with the new ornamental treatment can be sealed if necessary and is then ready for use.

The resilient sheet 22 provides a cushioned member for receiving and holding the laminated sheet 12 having the thin tiles 16 during installation and use of the mosaic sheet 10 as a surface treatment. The mesh grid 14 holds the spacing of the tiles 16. The second mesh grid 28 holds the resilient sheet 22 substantially square and aligned during installation so that the linear gaps 18 defined by the tiles 16 do not come out of alignment. BONDERA tile matset sheet provided by W.R. Grace & Company, Grace Construction Products, Cambridge, Mass., provides a pressure-sensitive backer sheet suitable for use with the present invention.

The tile device and methods disclosed herein can be made and executed without undue experimentation in light of the present disclosure. While the apparatus of this invention have been described in terms of illustrated embodiments, it will be apparent to those of skill in the art that variations may be applied to the apparatus and in the process described herein without departing from the concept, spirit and scope of the invention. All such similar substitutes and modifications apparent to those skilled in the art are deemed to be within the spirit, scope and concept of the invention as defined by the appended claims.

What is claimed is:

1. A laminated tile mosaic sheet, comprising:
a laminated sheet comprising:
a mesh grid; and
a plurality of tiles attached in spaced apart relation to the mesh grid, adjacent tiles defining gaps therebetween and each tile having an ornamental surface;
a backer sheet having a first adhesive surface and an opposing second adhesive surface, the first laminated sheet attached to the first adhesive surface;
the backer sheet including a second mesh grid; and
a cover sheet detachably attached to the second adhesive surface,
whereby the tile mosaic sheet attaches to a surface upon removal of the detachable cover sheet.

2. The laminated tile mosaic sheet as recited in claim 1, wherein the tiles are thin-cut stone.

3. The laminated tile mosaic sheet as recited in claim 1, wherein the tiles are natural stone having a thickness of about 4 mm.

4. The laminated tile mosaic sheet as recited in claim 1, wherein the second mesh grid attaches to the first adhesive surface and the laminated sheet attaches thereto in overlying relation.

5. A method of making a laminated tile mosaic sheet, comprising the steps of:
(a) providing a laminated sheet having a plurality of spaced-apart tiles attached to a first mesh grid, the tiles are thin-cut natural stone having a thickness of about 4 mm;
(b) providing a second mesh grid to a backer sheet having a first adhesive surface and an opposing second adhesive surface;
(c) attaching the laminated sheet to the first adhesive surface of the backing sheet; and
(d) detachably attaching a cover sheet to the second adhesive surface.

6. The method as recited in claim 5, wherein the second mesh grid attaches to the first adhesive surface prior to step (c), wherein the laminated sheet attaches in overlying relation to the second mesh grid.

7. A method of installing a thin-tile mosaic sheet for ornamental treatment of a wall surface, comprising the steps of:
(a) providing a plurality of laminated tile mosaic sheets, each laminated tile mosaic sheet comprising:
a laminated sheet comprising:
a mesh grid; and
a plurality of tiles attached in spaced apart relation to the mesh grid, adjacent tiles defining gaps therebetween and each tile having an ornamental surface;
a backer sheet having a first adhesive surface and an opposing second adhesive surface, the first laminated sheet attached to the first adhesive sheet;
the backer sheet including a second mesh grid; and
a cover sheet detachably attached to the second adhesive surface;
(b) removing the detachable cover sheet of one of the laminated tile mosaic sheets;
(c) attaching the laminated tile mosaic sheet in overlying relation to a predetermined portion of a wall surface without previously removing an existing ornamental treatment on the wall surface;
(d) repeating steps (b) and (c) until a desired portion of the wall surface is covered with the attached laminated tile mosaic sheets;
(e) applying a grout material to fill at least partially the gaps between adjacent tiles; and
(f) wiping grout material from the ornamental surface of the tiles.

8. The method as recited in claim 7, wherein the tiles are thin-cut stone.

9. The method as recited in claim 7, wherein the tiles are natural stone having a thickness of about 4 mm.

10. The method as recited in claim 7, wherein the second mesh grid attaches to the first adhesive surface and the laminated sheet attaches in overlying relation to the second mesh grid.
